(19) United States
(12) Patent Application Publication
(10) Pub. No.: US 2009/0206094 A1
(43) Pub. Date: Aug. 20, 2009

(54) PROPANE GAS CYLINDER ASSEMBLY

(76) Inventor: Paul W. Soutullo, Daphne, AL (US)

Correspondence Address: ASHLEY LAW FIRM P.C., 3440 TORINGDON WAY, SUITE 205, CHARLOTTE, NC, 28277, US

(21) Appl. No.: 12/184,433

(22) Filed: Aug. 1, 2008

(51) Int. Cl. F17C 13/06; B65D 53/00

(52) U.S. Cl. 220/582; 215/344; 206/6

(57) ABSTRACT

A propane gas container assembly includes a bottle adapted for containing about 16.4 ounces of propane gas having a substantially circular outlet nozzle for exiting propane gas, on which a plurality of threads are formed, and a cap having a circular top section, a substantially circular sidewall extending from the top section, and a plurality of threads formed on an internal surface of the sidewall for complementary engagement with the threads formed on the exterior surface of the outlet nozzle of the bottle. A rubber sealing member is positioned on the internal surface of the top section of the cap, and is adapted for forming a substantially gas tight seal to prevent the escape of propane gas from the bottle when the cap is threadingly engaged to the outlet nozzle of the bottle. The rubber sealing member can cover the entire internal surface of the top section of the cap, and can be made of nitrile.

### TECHNICAL FIELD AND BACKGROUND OF THE INVENTION

The present invention relates to a closure device for gas tanks. A particular embodiment of the invention comprises a screw-on, non-ferrous cap configured specifically for closing and preventing gas leakage in standard 16.4 oz. sized propane gas cylinders (also known as “propane bottles”).

There are a variety of portable outdoor appliances today, such as tabletop grills and propane torches, that operate on propane gas. The propane gas fuel for these appliances are typically stored in 16.4 ounce (oz.) bottles that are easily transportable along with the appliances.

These 16.4 ounce propane bottles are the standard means for transporting propane gas for portable outdoor propane gas appliances. These bottles are typically sold with a basic plastic cap positioned on the outlet nozzle of the bottle. However, these basic plastic caps do not form a gas tight seal with the outlet nozzle and as such do not adequately prevent leakage of propane gas when the bottles are not hooked up to an appliance. Such leakage of propane gas can be dangerous as well as economically inefficient. Accordingly, there is a need for a mechanism to prevent such leakage in 16.4 oz. propane gas bottles.

### SUMMARY OF THE INVENTION

Therefore, an object of the present invention is to provide a closure mechanism particularly adapted for 16.4 oz. standard propane gas bottles.

Another object of the present invention is to provide a cap that engages the outlet nozzle of 16.4 oz. propane gas bottles and forms a gas tight seal therewith.

These and other objects of the present invention can be achieved in the preferred embodiments of the invention disclosed below. One embodiment of the invention comprises a bottle adapted for containing about 16.4 ounces of propane gas having a substantially circular outlet nozzle for exiting propane gas, on which a plurality of threads are formed, and a cap having a circular top section, a substantially circular sidewall extending from the top section, and a plurality of threads formed on an internal surface of the sidewall for complementary engagement with the threads formed on the exterior surface of the outlet nozzle of the bottle. A sealing member is positioned on an internal surface of the top section of the cap, and is adapted for forming a substantially gas tight seal to prevent the escape of propane gas from the bottle when the cap is threadingly engaged to the outlet nozzle of the bottle.

According to another embodiment of the invention, the sealing member covers the entire internal surface of the top section of the cap.

According to another embodiment of the invention, the sealing member is made of rubber.

According to another embodiment of the invention, the sealing member is made of Nitrile, also known as Buna-N or NBR.

According to another embodiment of the invention, the plurality of threads formed on the internal surface of the sidewall of the cap are sized at twenty threads per inch.

According to another embodiment of the invention, the plurality of threads formed on the internal surface of the sidewall of the cap are right handed threads.

According to another embodiment of the invention, the outer surface of the sidewall of the cap is knurled to facilitate grasping and turning of the cap.

According to another embodiment of the invention, the outer surface of the sidewall of the cap defines an outer diameter of the cap of 1.175 inches.

According to another embodiment of the invention, the threaded internal surface of the sidewall defines a minor inner diameter of 0.937 inches, and a major inner diameter of 1.005 inches.

According to another embodiment of the invention, the cap has a height of 0.625 inches.

According to another embodiment of the invention, the threads formed on the internal surface of the sidewall of the cap extend for 0.325 inches.

According to another embodiment of the invention, there are at least six and no more than eight threads formed on the internal surface of the sidewall of the cap.

According to another embodiment of the invention, the top section and the sidewall of the cap are made of brass and/or aluminum.

### BRIEF DESCRIPTION OF THE DRAWINGS

FIG. 1 is a front elevation of a propane gas container assembly according to a preferred embodiment of the invention;

FIG. 2 is a front elevation of the propane bottle in FIG. 1

FIG. 3 is a bottom plan view the cap in FIG. 1;

FIG. 4 is a cross sectional view taken along lines 4-4 of FIG. 3; and

FIG. 5 is a perspective view of the cap in FIG. 1.

### DETAILED DESCRIPTION OF THE INVENTION AND BEST MODE

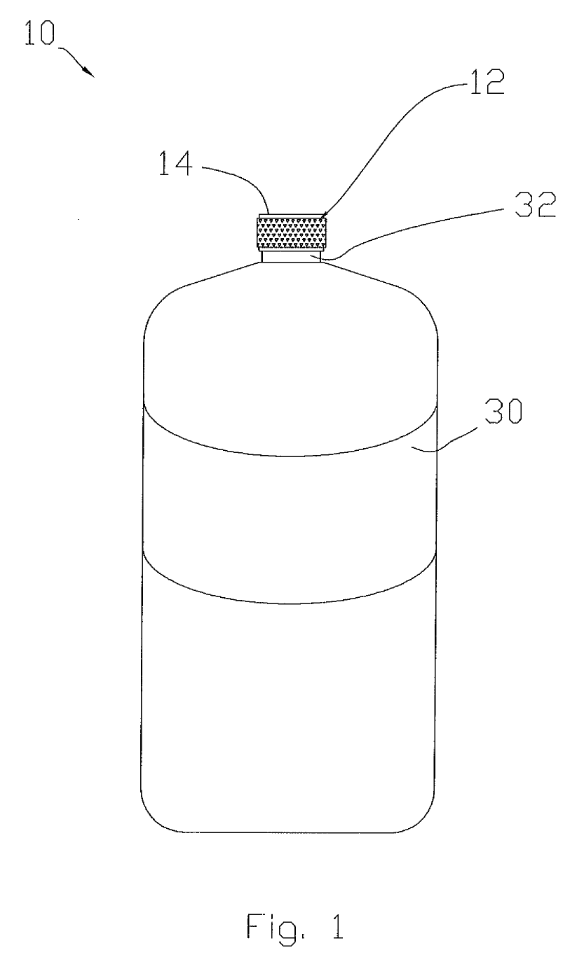

A propane gas container assembly according to a preferred embodiment of the invention is illustrated in FIG. 1, and shown generally at reference numeral 10. The assembly comprises a cap 12 that engages the outlet nozzle 32 of a 16.4 oz. propane gas bottle 30, and forms a gas tight seal therewith.

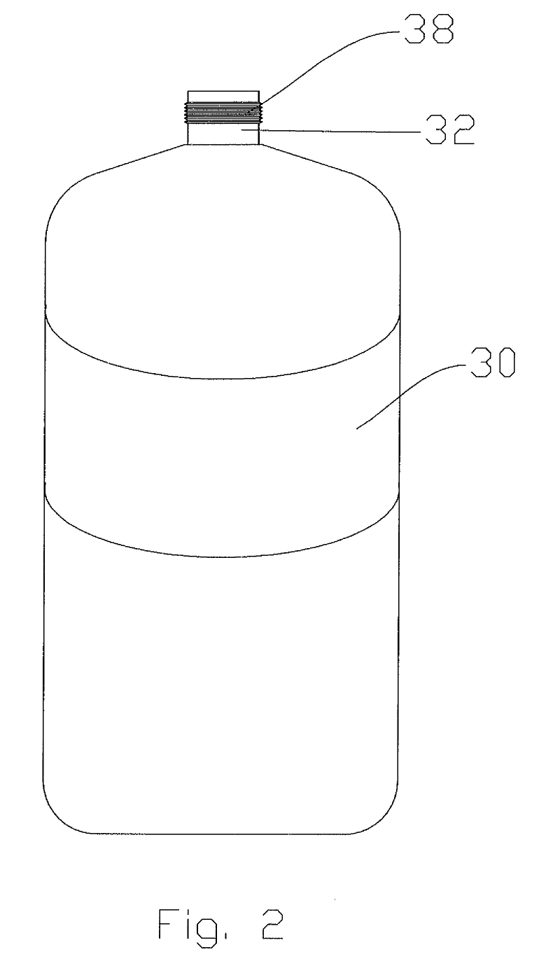

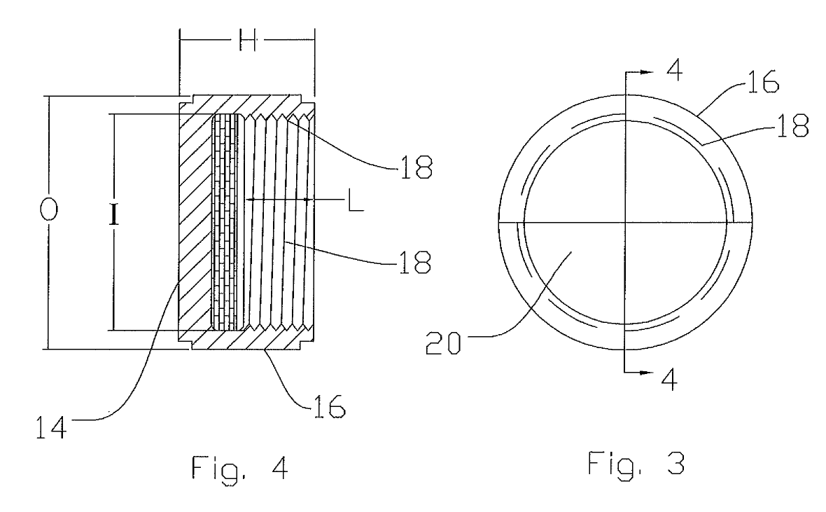

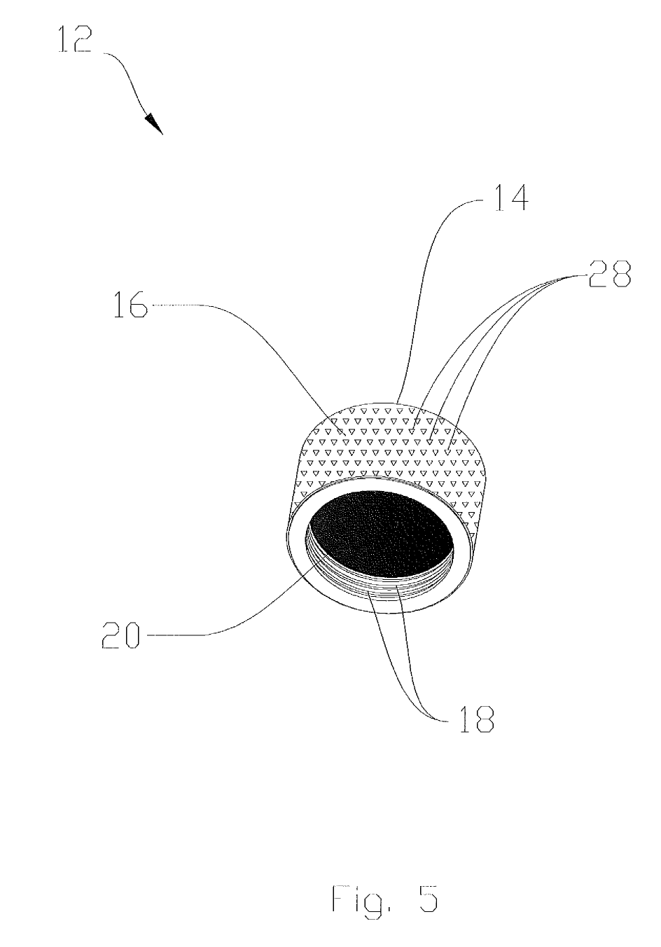

The cap 12 is preferably made of brass and/or aluminum, or another suitable non-ferrous material. The cap includes a substantially flat top section 14 and a substantially circular sidewall 16 extending downward from the top section 14, as shown in FIGS. 2 and 3. A series of threads 18 are formed on the internal surface of the sidewall 16. The threads 18 are preferably right handed threads, and are formed in the internal surface of the sidewall 16 of the cap 12 at a size of twenty threads per inch. Preferably, there are at least six threads and no more than eight threads. The outer surface of the sidewall has knurling 28 to facilitate grasping and turning of the cap.

A sealing member 20 is attached to the internal surface of the top section 14. The sealing member 20 is preferably made of a rubber, such as Nitrile, also known as Buna-N or NBR, and is rated for propane gas cylinders. The sealing member 20 covers substantially the entire internal surface of the top section 14.

Threads 38 are formed on the external surface of the outlet nozzle 32 of the propane bottle 30. The threads 18 of the cap are complementary to the threads 38 of the bottle 30, such that the cap 12 can be screwed onto the outlet nozzle 32 of the propane bottle 30. The cap threads 18 engage the bottle threads 38, and a leak-proof seal is formed as the cap 12 is tightened onto the nozzle 32. As such, the cap 12 helps prevent propane gas leakage and damage to the outlet nozzle 32 while not in use or during storage.

The cap 12 has the following preferred dimensions, as shown in FIG. 3. The threads are sized at twenty threads per inch, and extend for a length “L” of approximately 0.325 inches in the internal surface of the sidewall 16. The cap 12 has an outer diameter “O” of 1.175 inches, and a major inner diameter “I” of 1.005. The threaded internal surface of the sidewall 16 defines a minor inner diameter of 0.937 inches. The cap has a height “H” of 0.625 inches. Preferably, the area of the internal surface of the sidewall 16 in which the sealing member 20 is housed has a slightly larger diameter than the minor inner diameter defined by the threading 18. This allows the sealing member to stay in place whenever one turns the cap in any direction, and prevents it from falling out.

In an alternative embodiment, a slot can be formed in the head of the cap to receive a flat head screw driver in case the cap becomes stuck on the tank due to cold weather, etc.

A propane gas container assembly and method of using same are described above. Various changes can be made to the invention without departing from its scope. The above detailed description of the preferred embodiments and best mode of the invention are provided for the purpose of illustration only and not limitation—the invention being defined by the following claims.

What is claimed is:

1. A propane gas container assembly comprising:
(a) a bottle adapted for containing about 16.4 ounces of propane gas, and including a substantially circular outlet nozzle for exiting propane gas therefrom, wherein a plurality of threads are formed on an exterior surface of the outlet nozzle; and
(b) a cap comprising
(i) a circular top section,
(ii) a substantially circular sidewall extending from the top section,
(iii) a plurality of threads formed on an internal surface of the sidewall for complementary engagement with the threads formed on the exterior surface of the outlet nozzle, and
(iv) a sealing member positioned on an internal surface of the top section of the cap and adapted for forming a substantially gas tight seal to prevent the escape of propane gas from the bottle when the cap is threadingly engaged to the outlet nozzle of the bottle.

2. A propane gas container assembly according to claim 1, wherein the sealing member covers the entire internal surface of the top section of the cap.

3. A propane gas container assembly according to claim 1, wherein the sealing member is comprised of rubber.

4. A propane gas container assembly according to claim 1, wherein the sealing member is comprised of Nitrile.

5. A propane gas container assembly according to claim 1, wherein the plurality of threads formed on the internal surface of the sidewall of the cap are sized at twenty threads per inch.

6. A propane gas container assembly according to claim 1, wherein the plurality of threads formed on the internal surface of the sidewall of the cap are right handed threads.

7. A propane gas container assembly according to claim 1, wherein an outer surface of the sidewall of the cap is knurled to facilitate grasping and turning of the cap.

8. A propane gas container assembly according to claim 1, wherein an outer surface of the sidewall of the cap defines an outer diameter of the cap of 1.175 inches.

9. A propane gas container assembly according to claim 1, wherein the threaded internal surface of the sidewall defines a minor inner diameter of 0.937 inches, and a major inner diameter of 1.005 inches.

10. A propane gas container assembly according to claim 1, wherein the cap has a height of 0.625 inches.

11. A propane gas container assembly according to claim 1, wherein the threads formed on the internal surface of the sidewall of the cap extend for 0.325 inches.

12. A propane gas container assembly according to claim 1, wherein the plurality of threads formed on the internal surface of the sidewall of the cap comprise at least six threads and no more than eight threads.

13. A propane gas container assembly according to claim 1, wherein the top section and the sidewall of the cap comprise one or more materials selected from the group consisting of brass and aluminum.

14. A method of containing and storing propane gas comprising the steps of:
(a) providing a bottle adapted for containing about 16.4 ounces of propane gas, and including a substantially circular outlet nozzle for exiting propane gas therefrom, wherein a plurality of threads are formed on an exterior surface of the outlet nozzle;
(b) providing a cap comprising
(i) a circular top section,
(ii) a substantially circular sidewall extending from the top section,
(iii) a plurality of threads formed on an internal surface of the sidewall for complementary engagement with the threads formed on the exterior surface of the outlet nozzle, and
(iv) a rubber sealing member positioned on an internal surface of the top section of the cap and adapted for forming a substantially gas tight seal to prevent the escape of propane gas from the bottle when the cap is threadingly engaged to the outlet nozzle of the bottle; and
(c) positioning the cap on the outlet nozzle of the bottle and turning the cap to threadingly engage the cap to the nozzle.

15. A method according to claim 14, wherein the rubber sealing member is comprised of Nitrile.
